(19) United States
(12) Patent Application Publication
(10) Pub. No.: US 2025/0175544 A1
(43) Pub. Date: May 29, 2025

(54) ENCAPSULATED INTERNET PROTOCOL TRANSPORT DATA PACKETS COMMUNICATED IN CABLE NETWORKS

(71) Applicant: Juniper Networks, Inc., Sunnyvale, CA (US)

(72) Inventor: Venkatesh PADEBETTU, Bangalore (IN)

(21) Appl. No.: 18/796,783

(22) Filed: Aug. 7, 2024

(30) Foreign Application Priority Data
Nov. 28, 2023 (IN) 202341080510
Nov. 28, 2023 (IN) 202341080529

(51) Int. Cl. H04L 69/22; H04L 47/43; H04W 28/06

(52) U.S. Cl. CPC H04L 69/22; H04L 47/43; H04W 28/065; H04L 2212/00

(57) ABSTRACT

In some implementations, a client device may send to an access gateway function (AGF) device, and via a wireline connection, one or more first encapsulated Internet protocol (IP) transport data packets. The client device may receive from the AGF device, and via the wireline connection, one or more second encapsulated IP transport data packets. In some implementations, the one or more first encapsulated IP transport data packets are sent via a general packet radio service (GPRS) tunneling protocol (GTP) for user data (GTP-U) tunnel over the wireline connection, and the one or more second encapsulated IP transport data packets are received via the GTP-U tunnel.

### CROSS-REFERENCE TO RELATED APPLICATION

This Patent Application claims priority to Indian Patent Application No. 202341080510, filed on Nov. 28, 2023, and entitled “NON-ACCESS STRATUM TRANSPORT FOR CLIENT DEVICES IN CABLE NETWORKS” and to Indian Patent Application No. 202341080529 filed on Nov. 28, 2023, and entitled “TRANSPORT FOR CLIENT DEVICE DATA PACKETS IN CABLE NETWORKS.” The disclosure of the prior Applications are considered part of and is incorporated by reference into this Patent Application.

### BACKGROUND

A client device (e.g., a residential gateway, a customer premises equipment (CPE), a user equipment (UE), and/or the like) may be connected to a fifth generation (5G) core network via a wireline connection (e.g., information is transmitted over a physical element, such as a fiber optic able, a coaxial cable, a twisted pair cable, and/or the like).

### SUMMARY

In some implementations, a method includes sending, by a client device, to an access gateway function (AGF) device, and via a wireline connection, one or more first encapsulated Internet protocol (IP) transport data packets; and receiving, by the client device, from the AGF device, and via the wireline connection, one or more second encapsulated IP transport data packets.

In some implementations, an AGF device includes one or more memories; and one or more processors to: receive, from a client device and via a wireline connection, one or more first encapsulated IP transport data packets; and send, to the client device, via the wireline connection, one or more second encapsulated IP transport data packets.

In some implementations, a non-transitory computer-readable medium storing a set of instructions includes one or more instructions that, when executed by one or more processors of an AGF device, cause the AGF device to: receive, from a client device and via a wireline connection, one or more first encapsulated IP transport data packets; and send, to a user plane function (UPF) device, based on the one or more first encapsulated IP transport data packets, one or more second encapsulated IP transport data packets.

### BRIEF DESCRIPTION OF THE DRAWINGS

FIGS. 1A-1B are diagrams of an example implementation associated with encapsulated Internet protocol (IP) transport data packets communicated in cable networks.

FIG. 2 is a diagram of an example protocol stack associated with systems and/or methods described herein.

FIG. 3 is a diagram of an example user plane stack associated with systems and/or methods described herein.

FIG. 4 is a diagram of an example environment in which systems and/or methods described herein may be implemented.

FIG. 5 is a diagram of example components of a device associated with encapsulated IP transport data packets communicated in cable networks.

FIG. 6 is a diagram of example components of a device associated with encapsulated IP transport data packets communicated in cable networks.

FIG. 7 is a flowchart of an example process associated with encapsulated IP transport data packets communicated in cable networks.

FIG. 8 is a flowchart of an example process associated with encapsulated IP transport data packets communicated in cable networks.

### DETAILED DESCRIPTION

The following detailed description of example implementations refers to the accompanying drawings. The same reference numbers in different drawings may identify the same or similar elements.

To allow a client device that is connected to a fifth generation (5G) core network to communicate, the client device needs to send and receive data packets via the 5G core network. When the client device is connected to the 5G core via a wireless connection (e.g., when the client device is a 5G residential gateway (5G-RG)), the client device can utilize point-to-point protocol over Ethernet (PPPoE) to transport data packets to and from the core network. However, such an approach cannot be utilized when the client device is connected to the 5G core via a cable network connection (i.e., a type of wireline connection). This is because only Internet protocol (IP) can be used to transport messages via cable network connections. For example, in a cable network (e.g., a data over cable service interface specification (DOCSIS) cable network), a client device (e.g., a cable modem) is assigned an IP address by a service provider, and therefore the IP address is to be included in data packets that are communicated between the client device and a cable modem termination system (CMTS) of the cable network. This type of functionality cannot be changed, and thereby prevents adoption of PPPoE-based transport for cable networks.

Consequently, when the client device (e.g., a cable modem of a cable network) is connected to a core network via a wireline connection (e.g., a cable network connection), there is currently no way to transport data packets between the client device and the core network. Thus, there exists a need for a transport protocol to allow communication of data packets via a wireline connection (e.g., that is associated with a cable network).

Some implementations described herein provide a transport protocol between a client device (e.g., a 5G cable residential gateway (5G-CRG)) and an access gateway function (AGF) device associated with a core network, where the client device is connected to the AGF device via a wireline connection (e.g., a cable network connection). The transport protocol may utilize IP and user datagram protocol (UDP) (e.g., to allow communication between the client device and the AGF device), and may also utilize an IP tunnel, such as a general packet radio service (GPRS) tunneling protocol (GTP) for user data (GTP-U) tunnel, to secure communications between the client device and the AGF device.

For example, the client device may send one or more first encapsulated IP transport data packets to the AGF device (e.g., via an IP tunnel, such as a GTP-U tunnel, between the client device and the AGF device). Accordingly, the one or more first encapsulated IP transport data packets may include a header (e.g., an IP tunnel header, such as a GTP-U header), which may include a tunnel endpoint identifier (TEID) (e.g., that identifies the AGF device as an endpoint of the tunnel) and/or quality of service (QoS) information that includes, for example, a QoS flow identifier (QFI) associated with a flow of the one or more first encapsulated IP transport data packets, a reflective QoS identifier (RQI) associated with the flow (e.g., that indicates whether reflective QoS is active for the flow), and/or other QoS information. The AGF device may therefore decapsulate the one or more first encapsulated IP transport data packets (e.g., as the endpoint of the tunnel), and, in some implementations, may generate (e.g., based on the decapsulated one or more first encapsulated IP transport data packets) one or more second encapsulated IP transport data packets and may send the one or more second encapsulated IP transport data packets to the core network (e.g., to a user plane function (UPF) device of the core network, such as via another tunnel between the AGF device and the UPF device). In this way, some implementations enable the client device to send data packets to the core network via a wireline connection (e.g., a cable network connection).

Additionally, or alternatively, the AGF device may receive one or more third encapsulated IP transport data packets from the core network (e.g., from UPF device, such as via the other tunnel between the AGF device and the UPF device). The AGF device may therefore decapsulate the one or more third encapsulated IP transport data packets (e.g., as an endpoint of the other tunnel), and, in some implementations, may generate (e.g., based on the decapsulated one or more third encapsulated IP transport data packets) one or more fourth encapsulated IP transport data packets and may send the one or more fourth encapsulated IP to the client device over the wireline connection (e.g., via the tunnel between the AGF device and the client device). Accordingly, the one or more fourth encapsulated IP transport data packets may include a header (e.g., an IP tunnel header, such as a GTP-U header), which may include a TEID (e.g., that identifies the client device as an endpoint of tunnel) and/or other QoS information (e.g., that was included in the one or more third encapsulated IP transport data packets). In this way, some implementations enable the client device to receive data packets from the core network via a wireline connection (e.g., a cable network connection).

Thus, some implementations described herein enable the client device to communicate data packets (e.g., to and from the core network) via a wireline connection using IP-based packets, such as packets associated with an IP tunnel protocol (e.g., GTP-U). Communicating data packets via the wireline connection would not otherwise be possible. In this way, some implementations described herein enable a client device associated with a wireline network, such as a cable network, to be serviced by a core network (e.g., a 5G network).

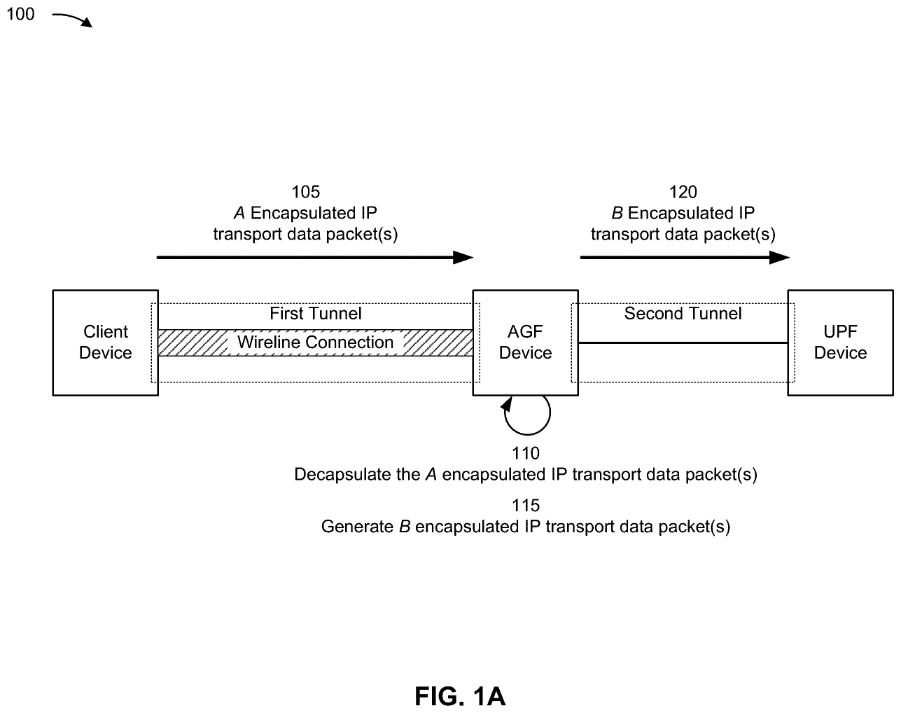

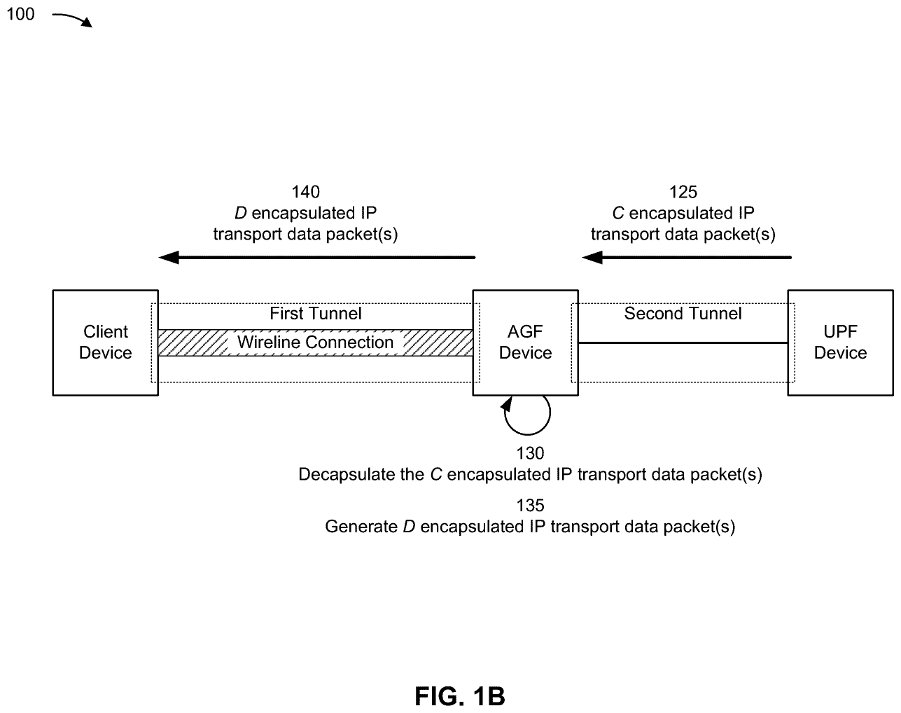

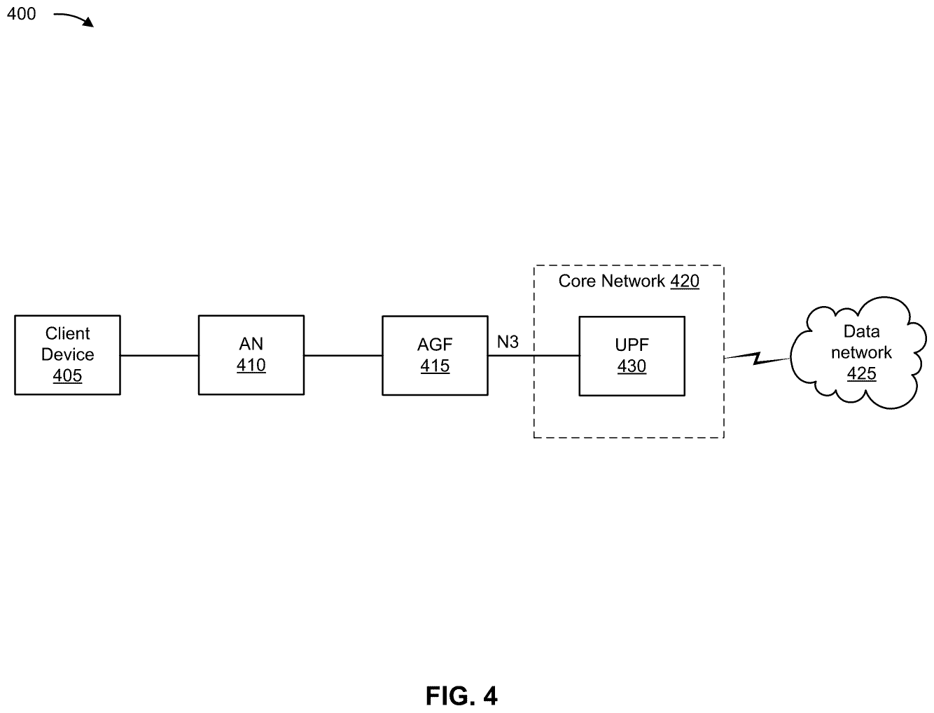

FIGS. 1A-1B are diagrams of an example implementation 100 associated with encapsulated IP transport data packets communicated in cable networks. As shown in FIGS. 1A-1B, example implementation 100 includes a client device, an AGF device, and/or a UPF device. These devices are described in more detail below in connection with FIGS. 4-6.

The client device, the AGF device, and the UPF device may be associated with a core network. The core network may include an example architecture of a 5G next generation (NG) core network included in a 5G wireless telecommunications system, and may include physical elements, virtual elements, or a combination of physical and virtual elements. The client device may include a network device (e.g., a residential gateway, such as a 5G-RG, a 5G-CRG, or another type of residential gateway), a customer premises equipment (CPE), a user equipment (UE), and/or another type of device. The AGF may facilitate the client device communicating with one or more functional elements of the core network, such as functional elements associated with the UPF device (e.g., that is included in the core network).

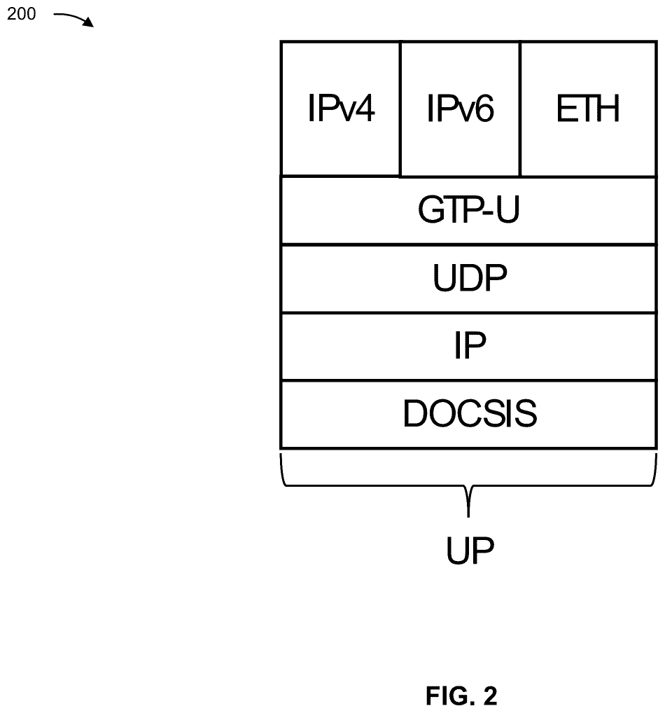

As shown in FIGS. 1A-1B, the client device may be connected to the AGF via a wireline connection. The wireline connection may include, for example, a cable network connection, or another type of wireline connection. The wireline connection may be associated with a transport protocol (e.g., that is associated with the example protocol stack 200 described herein in connection with FIG. 2) that is used to carry data packets between the client device and the AGF (and functional elements of the core network). For example, the wireline connection may be an IP wireline connection, where IP messages are communicated via the wireline connection. In some implementations, the wireline connection may be a particular type of IP wireline connection, such as a UDP wireline connection (e.g., where UDP packets are encapsulated in IP messages). In some implementations, the wireline connection may support a tunnel (e.g., an IP tunnel) between the client device and the AGF device. For example, the wireline connection may support a GTP-U tunnel, or a similar tunnel.

As shown in FIG. 1A, and by reference number 105, the client device may send one or more A encapsulated IP transport data packets to the AGF device (e.g., when the wireline connection is an IP wireline connection). For example, the client device may send the one or more A encapsulated IP transport data packets via the wireline connection between the client device and the AGF device, and therefore the AGF device may receive the one or more A encapsulated IP transport data packets from the client device via the wireline connection. In some implementations, as shown in FIG. 1A, a first tunnel (e.g., an IP tunnel, such as a GTP-U tunnel) may be established over the wireline connection. Accordingly, the client device may send the one or more A encapsulated IP transport data packets via the first tunnel (e.g., over the wireline connection), and therefore the AGF device may receive the one or more A encapsulated IP transport data packets from the client device via the first tunnel (e.g., over the wireline connection).

Each encapsulated IP transport data packet of the one or more A encapsulated IP transport data packets may include one or more headers (e.g., that encapsulate a data payload). For example, each encapsulated IP transport data packet may include an IP header and, in some cases, a UDP header (e.g., when the wireline connection is a UDP wireline connection). In some implementations, when the first tunnel is established over the wireline connection, each encapsulated IP transport data packet may include a header associated with the first tunnel. For example, when the first tunnel is a GTP-U tunnel, each encapsulated IP transport data packet may include a GTP-U header (e.g., in addition to an IP header and a UDP header).

Accordingly, each encapsulated IP transport data packet of the one or more A encapsulated IP transport data packets may include a header that includes a TEID and/or QoS information. The TEID may be associated with the AGF device (e.g., the TEID may indicate that the AGF device is an endpoint of the first tunnel). The QoS information may include, for example, a QFI associated with a flow of the one or more A encapsulated IP transport data packets, an RQI associated with the flow (e.g., that indicates whether reflective QoS is active for the flow), and/or other QoS information. In some implementations, the header that includes the TEID and/or the QoS information is the header associated with the first tunnel (e.g., the GTP-U header).

As shown by reference number 110, the AGF device may decapsulate the one or more A encapsulated IP transport data packets. For example, the AGF device may perform one or more decapsulation operations on each encapsulated IP transport data packet of the one or more A encapsulated IP transport data packets to remove the one or more headers of the encapsulated IP transport data packet. In this way, the AGF device may remove an IP header, a UDP header, and/or a header associated with the first tunnel (e.g., a GTP-U header) from the encapsulated IP transport data packet (e.g., to obtain a decapsulated packet that includes only a data payload of the encapsulated IP transport data packet).

As shown by reference number 115, the AGF device may generate one or more B encapsulated IP transport data packets (e.g., based on the decapsulated one or more A encapsulated IP transport data packets). For example, the AGF device may generate a B encapsulated IP transport data packet to include a data payload of a corresponding decapsulated A encapsulated IP transport data packet. The B encapsulated IP transport data packet may include one or more headers (e.g., that encapsulate a data payload), such as an IP header, a UDP header, and/or a header associated with a second tunnel. The AGF device may be connected to the UPF device via an interface of the core network, such as an N3 interface (that is defined by the Third Generation Partnership Project (3GPP)) of the core network, and the second tunnel (e.g., an IP tunnel, such as a GTP-U tunnel) may be established over the interface. Accordingly, when the second tunnel is a GTP-U tunnel, the header associated with the second tunnel may be a GTP-U header. In some implementations, the header associated with the second tunnel may include a TEID associated with the UPF device (e.g., the TEID may indicate that the UPF device is an endpoint of the second tunnel) and/or the QoS information (e.g., when the QoS information was included in the header associated with the first tunnel that was included in the corresponding decapsulated A encapsulated IP transport data packet).

As shown by reference number 120, the AGF device may send the one or more B encapsulated IP transport data packets to the UPF device (e.g., when the interface is an IP interface). For example, the AGF device may send the one or more B encapsulated IP transport data packets via the interface between the AGF device and the UPF device, and therefore the UPF device may receive the one or more B encapsulated IP transport data packets from the AGF device via the interface. In some implementations, the AGF device may send the one or more B encapsulated IP transport data packets via the second tunnel (e.g., over the interface), and therefore the UPF device may receive the one or more B encapsulated IP transport data packets from the AGF device via the second tunnel. The AGF device may send the one or more B encapsulated IP transport data packets in accordance with the QoS information, such as by sending the one or more B encapsulated IP transport data packets such that one or more QoS criteria (e.g., that includes a latency criterion, a throughput criterion, or a bandwidth criterion, among other examples) associated with the QoS information are satisfied.

As shown in FIG. 1B, and by reference number 125, the UPF device may send one or more C encapsulated IP transport data packets to the AGF device (e.g., when the interface between the AGF device and the UPF device is an IP interface). For example, the UPF device may send the one or more C encapsulated IP transport data packets via the interface between the client device and the AGF device, and therefore the AGF device may receive the one or more C encapsulated IP transport data packets from the UPF device via the interface. In some implementations, as shown in FIG. 1B, the UPF device may send the one or more C encapsulated IP transport data packets via the second tunnel (e.g., over the interface), and therefore the AGF device may receive the one or more C encapsulated IP transport data packets from the UPF device via the second tunnel (e.g., over the interface).

Each encapsulated IP transport data packet of the one or more C encapsulated IP transport data packets may include one or more headers (e.g., that encapsulate a data payload). For example, each encapsulated IP transport data packet may include an IP header and, in some cases, a UDP header (e.g., when the interface is a UDP interface). In some implementations, when the second tunnel is established over the interface, each encapsulated IP transport data packet may include a header associated with the second tunnel. For example, when the second tunnel is a GTP-U tunnel, each encapsulated IP transport data packet may include a GTP-U header (e.g., in addition to an IP header and a UDP header).

Accordingly, each encapsulated IP transport data packet of the one or more C encapsulated IP transport data packets may include a header that includes a TEID and/or QoS information. The TEID may be associated with the AGF device (e.g., the TEID may indicate that the AGF device is an endpoint of the second tunnel). The QoS information may include, for example, a QFI associated with a flow of the one or more C encapsulated IP transport data packets, an RQI associated with the, and/or other QoS information. In some implementations, the header that includes the TEID and/or the QoS information is the header associated with the second tunnel (e.g., the GTP-U header).

As shown by reference number 130, the AGF device may decapsulate the one or more C encapsulated IP transport data packets. For example, the AGF device may perform one or more decapsulation operations on each encapsulated IP transport data packet of the one or more C encapsulated IP transport data packets to remove the one or more headers of the encapsulated IP transport data packet. In this way, the AGF device may remove an IP header, a UDP header, and/or a header associated with the second tunnel (e.g., a GTP-U header) from the encapsulated IP transport data packet (e.g., to obtain a decapsulated packet that includes only a data payload of the encapsulated IP transport data packet).

As shown by reference number 135, the AGF device may generate one or more D encapsulated IP transport data packets (e.g., based on the decapsulated one or more C encapsulated IP transport data packets). For example, the AGF device may generate a D encapsulated IP transport data packet to include a data payload of a corresponding decapsulated C encapsulated IP transport data packet. The D encapsulated IP transport data packet may include one or more headers (e.g., that encapsulate a data payload), such as an IP header, a UDP header, and/or a header associated with the first tunnel. Accordingly, when the first tunnel is a GTP-U tunnel, the header associated with the first tunnel may be a GTP-U header. In some implementations, the header associated with the first tunnel may include a TEID associated with the client device (e.g., the TEID may indicate that the client device is an endpoint of the first tunnel) and/or the QoS information (e.g., when the QoS information was included in the header associated with the second tunnel that was included in the corresponding decapsulated C encapsulated IP transport data packet).

As shown by reference number 140, the AGF device may send the one or more D encapsulated IP transport data packets to the client device (e.g., when the wireline connection is an IP connection). For example, the AGF device may send the one or more D encapsulated IP transport data packets via the wireline connection between the AGF device and the client device, and therefore the client device may receive the one or more D encapsulated IP transport data packets from the AGF device via the wireline connection. In some implementations, the AGF device may send the one or more D encapsulated IP transport data packets via the first tunnel (e.g., over the wireline connection), and therefore the client device may receive the one or more D encapsulated IP transport data packets from the AGF device via the first tunnel. The AGF device may send the one or more D encapsulated IP transport data packets in accordance with the QoS information, such as by sending the one or more D encapsulated IP transport data packets such that one or more QoS criteria (e.g., that includes a latency criterion, a throughput criterion, or a bandwidth criterion, among other examples) associated with the QoS information are satisfied.

As indicated above, FIGS. 1A-1B are provided as an example. Other examples may differ from what is described with regard to FIGS. 1A-1B. The number and arrangement of devices shown in FIGS. 1A-1B are provided as an example. In practice, there may be additional devices, fewer devices, different devices, or differently arranged devices than those shown in FIGS. 1A-1B. Furthermore, two or more devices shown in FIGS. 1A-1B may be implemented within a single device, or a single device shown in FIGS. 1A-1B may be implemented as multiple, distributed devices. Additionally, or alternatively, a set of devices (e.g., one or more devices) shown in FIGS. 1A-1B may perform one or more functions described as being performed by another set of devices shown in FIGS. 1A-1B.

FIG. 2 is a diagram of an example protocol stack 200 associated with systems and/or methods described herein. The example protocol stack 200 may be referred to as a 5G-CRG protocol stack. As shown in FIG. 2, the example protocol stack 200 is associated with a user plane (UP) of a core network (e.g., core network 420 described herein). As further shown in FIG. 2, the example protocol stack 200 may include a wireline connection portion (e.g., that is associated with a cable network protocol, such as a DOCSIS protocol, or another wireline connection protocol), an IP portion (e.g., that is encapsulated in the wireline connection portion), a UDP portion (e.g., that is encapsulated in the IP portion). A GTP-U portion that is configured to include address information (e.g., an IP version 4 (IPv4) address, an IP version 6 (IPv6) address, or an Ethernet (ETH) address) may be included (e.g., encapsulated) in the UDP portion of the example protocol stack 200.

As indicated above, FIG. 2 is provided as an example. Other examples may differ from what is described with regard to FIG. 2.

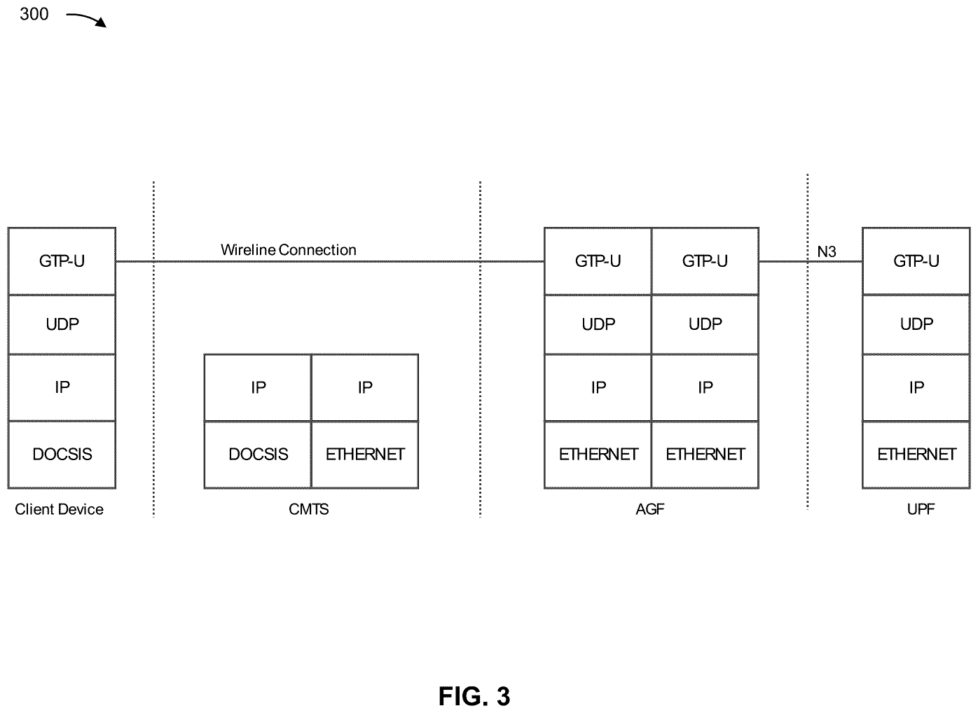

FIG. 3 is a diagram of an example user plane stack 300 associated with systems and/or methods described herein. The example user plane stack 300 is associated with a core network (e.g., core network 420 described herein). As further shown in FIG. 3, the example user plane stack 300, for a client device that is to communicate with the core network, may include a wireline connection portion (e.g., that is associated with a cable network protocol, such as a DOCSIS protocol, or another wireline connection protocol), an IP portion, a UDP portion, and a GTP-U portion (e.g., that is encapsulated in the UDP portion).

The example user plane stack 300, for a cable modem termination system (CMTS) that facilitates communication between the client device and the core network, may include a wireline connection portion (e.g., that is associated with a cable network protocol, such as a DOCSIS protocol, or another wireline connection protocol) and a first IP portion to facilitate communication between the client device and the CMTS via a wireline connection. Additionally, as further shown in FIG. 3, the example user plane stack 300, for the CMTS, may further include an Ethernet portion and a second IP portion to facilitate communication between the CMTS and the AGF device.

Further, the example user plane stack 300, for an AGF that facilitates communication between the client device and the core network, may include a first Ethernet portion, a first IP portion, a first UDP portion, and a first GTP-U portion to facilitate communication with the client device via a wireline connection between the client device and the AGF. Additionally, as further shown in FIG. 3, the example user plane stack 300, for the AGF, may further include a second Ethernet portion, a second IP portion, a second UDP portion, and a second GTP-U portion. Further, the example user plane stack 300, for a UPF of the core network, may include an Ethernet portion, an IP portion, a UDP portion, and a GTP-U portion to facilitate communication with the AGF via an interface (e.g., an N3 interface) between the AGF and the core network (e.g., the UPF).

As indicated above, FIG. 3 is provided as an example. Other examples may differ from what is described with regard to FIG. 3.

FIG. 4 is a diagram of an example environment 400 in which systems and/or methods described herein may be implemented. As shown in FIG. 4, example environment 400 may include client device 405, access network (AN) 410, AGF 415, a core network 420, and a data network 425. Devices and/or networks of example environment 400 may interconnect via wired connections, wireless connections, or a combination of wired and wireless connections.

Client device 405 includes one or more devices capable of receiving, generating, storing, processing, and/or providing information, such as information described herein. Client device 405 may be, may be similar to, or may include, the client device described herein in relation to FIGS. 1A-1B. Client device 405 may include a residential gateway (e.g., a 5G-CRG, a 5G-RG, or another type of residential gateway), a CPE, a UE, a network device (e.g., a label switching router (LSR), a label edge router (LER), an ingress router, an egress router, a provider router, a virtual router, a gateway, a switch, a firewall, a hub, a bridge, a reverse proxy, a proxy server, a cloud server, a data center server, a load balancer, and/or the like), or a similar type of device. In some implementations, client device 405 may receive network traffic from and/or may provide network traffic to core network 420, such as via AN 410 and AGF 415. In some implementations, client device 405 may be connected to AGF 415 via a wireline connection (which may or may not also connect AN 410).

AN 410 may include one or more nodes that are associated with a wireline connection to core network 420. AN 410 may include a central unit (CU) that includes an NG interface connecting the CU to a core unit (e.g., a next gen core (NGC) unit), which may be a node of core network 420. AN 410 may transfer traffic between client device 405 and core network 420. In some implementations, AN 410 may perform scheduling and/or resource management for client device 405 covered by AN 410. In some implementations, AN 410 may be controlled or coordinated by a network controller, which may perform load balancing, network-level configuration, and/or the like. A network controller may communicate with AN 410 via a wireless or wireline backhaul. In some implementations, AN 410 may include a network controller, a self-organizing network (SON) module or component, or a similar module or component. In other words, AN 410 may perform network control, scheduling, and/or network management functions (e.g., for uplink, downlink, and/or sidelink communications of client device 405 covered by AN 410).

AGF 415 may include one or more devices, between a wireline access infrastructure (e.g., AN 410) and core network 420, that support residential gateways (e.g., client device 405) that support 5G signaling and residential gateways that are purely wireline. AGF 415 connects to one or more functional elements of the core network 420 (e.g., UPF 430) via an N3 interface.

In some implementations, core network 420 may include an example functional architecture in which systems and/or methods described herein may be implemented. For example, core network 420 may include an example architecture of a 5G NG core network included in a 5G wireless telecommunications system. While the example architecture of core network 420 shown in FIG. 4 may be an example of a service-based architecture, in some implementations, core network 420 may be implemented as a reference-point architecture.

As shown in FIG. 4, core network 420 may include a number of functional elements. The functional elements may include, for example, UPF 430, as well as other functional elements. These functional elements may be implemented on one or more devices associated with a wireless telecommunications system. In some implementations, one or more of the functional elements may be implemented on physical devices, such as an access point, a base station, a gateway, and/or the like. In some implementations, one or more of the functional elements may be implemented on a computing device of a cloud computing environment.

UPF 430 includes one or more devices that serve as an anchor point for radio access technology (RAT) mobility (intraRAT and/or interRAT mobility) in the wireless telecommunications system. UPF 430 may apply rules to packets, such as rules pertaining to packet routing, traffic reporting, handling user plane QoS, and/or the like.

Data network 425 includes one or more wired and/or wireless data networks. For example, data network 425 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or the like, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example environment 400 may perform one or more functions described as being performed by another set of devices of example environment 400.

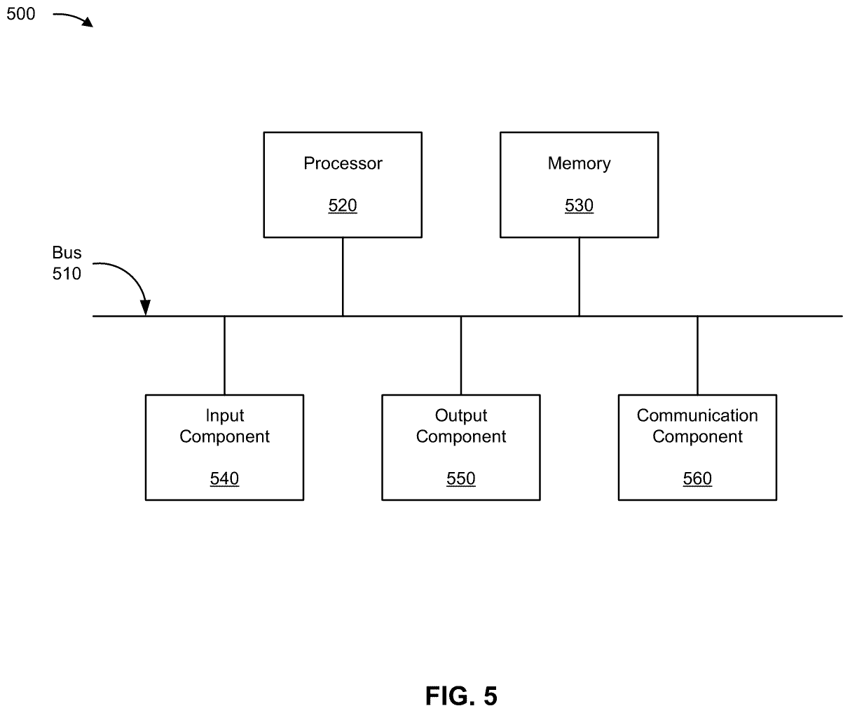

FIG. 5 is a diagram of example components of a device 500 associated with encapsulated IP transport data packets communicated in cable networks. The device 500 may correspond to client device 405, AN 410, AGF 415, and/or UPF 430. In some implementations, client device 405, AN 410, AGF 415, and/or UPF 430 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

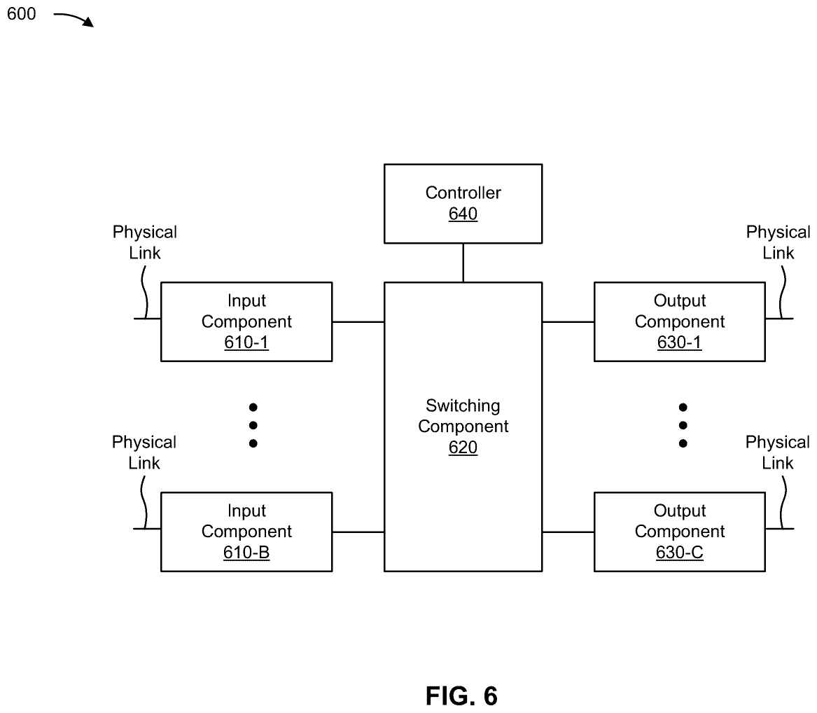

FIG. 6 is a diagram of example components of a device 600 associated with encapsulated IP transport data packets communicated in cable networks. Device 600 may correspond to client device 405, AN 410, AGF 415, and/or UPF 430. In some implementations, client device 405, AN 410, AGF 415, and/or UPF 430 may include one or more devices 600 and/or one or more components of device 600. As shown in FIG. 6, device 600 may include one or more input components 610-1 through 610-B (B≥1) (hereinafter referred to collectively as input components 610, and individually as input component 610), a switching component 620, one or more output components 630-1 through 630-C(C≥1) (hereinafter referred to collectively as output components 630, and individually as output component 630), and a controller 640.

Input component 610 may be one or more points of attachment for physical links and may be one or more points of entry for incoming traffic, such as packets. Input component 610 may process incoming traffic, such as by performing data link layer encapsulation or decapsulation. In some implementations, input component 610 may transmit and/or receive packets. In some implementations, input component 610 may include an input line card that includes one or more packet processing components (e.g., in the form of integrated circuits), such as one or more interface cards (IFCs), packet forwarding components, line card controller components, input ports, processors, memories, and/or input queues. In some implementations, device 600 may include one or more input components 610.

Switching component 620 may interconnect input components 610 with output components 630. In some implementations, switching component 620 may be implemented via one or more crossbars, via busses, and/or with shared memories. The shared memories may act as temporary buffers to store packets from input components 610 before the packets are eventually scheduled for delivery to output components 630. In some implementations, switching component 620 may enable input components 610, output components 630, and/or controller 640 to communicate with one another.

Output component 630 may store packets and may schedule packets for transmission on output physical links. Output component 630 may support data link layer encapsulation or decapsulation, and/or a variety of higher-level protocols. In some implementations, output component 630 may transmit packets and/or receive packets. In some implementations, output component 630 may include an output line card that includes one or more packet processing components (e.g., in the form of integrated circuits), such as one or more IFCs, packet forwarding components, line card controller components, output ports, processors, memories, and/or output queues. In some implementations, device 600 may include one or more output components 630. In some implementations, input component 610 and output component 630 may be implemented by the same set of components (e.g., and input/output component may be a combination of input component 610 and output component 630).

Controller 640 includes a processor in the form of, for example, central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor is implemented in hardware, firmware, or a combination of hardware and software. In some implementations, controller 640 may include one or more processors that can be programmed to perform a function.

In some implementations, controller 640 may include a RAM, a ROM, and/or another type of dynamic or static storage device (e.g., a flash memory, a magnetic memory, an optical memory, etc.) that stores information and/or instructions for use by controller 640.

In some implementations, controller 640 may communicate with other devices, networks, and/or systems connected to device 600 to exchange information regarding network topology. Controller 640 may create routing tables based on the network topology information, may create forwarding tables based on the routing tables, and may forward the forwarding tables to input components 610 and/or output components 630. Input components 610 and/or output components 630 may use the forwarding tables to perform route lookups for incoming and/or outgoing packets.

Controller 640 may perform one or more processes described herein. Controller 640 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with controller 640 from another computer-readable medium or from another device via a communication interface. When executed, software instructions stored in a memory and/or storage component associated with controller 640 may cause controller 640 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

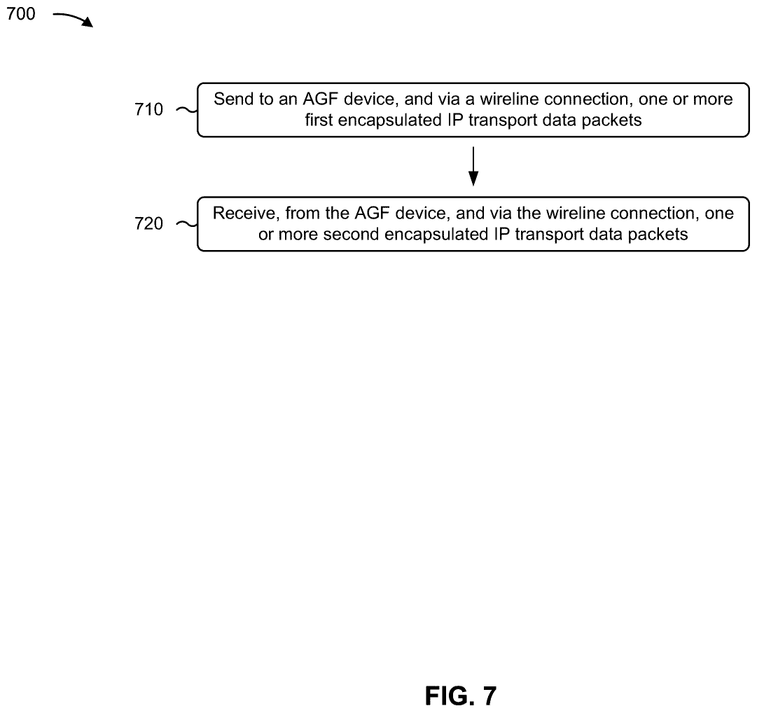

FIG. 7 is a flowchart of an example process 700 associated with encapsulated IP transport data packets communicated in cable networks. In some implementations, one or more process blocks of FIG. 7 are performed by a client device (e.g., client device 405). In some implementations, one or more process blocks of FIG. 7 are performed by another device or a group of devices separate from or including the client device, such as an AGF device (e.g., AGF 415) and/or a UPF device (e.g., UPF 430). Additionally, or alternatively, one or more process blocks of FIG. 7 may be performed by one or more components of device 500, such as processor 520, memory 530, input component 540, output component 550, and/or communication component 560. Additionally, or alternatively, one or more process blocks of FIG. 7 may be performed by one or more components of device 600, such as input component 610, switching component 620, output component 630, and/or controller 640.

As shown in FIG. 7, process 700 may include sending to an AGF device, and via a wireline connection, one or more first encapsulated IP transport data packets (block 710). For example, the client device may send to an AGF device, and via a wireline connection, one or more first encapsulated IP transport data packets, as described above.

As further shown in FIG. 7, process 700 may include receiving from the AGF device, and via the wireline connection, one or more second encapsulated IP transport data packets (block 720). For example, the client device may receive from the AGF device, and via the wireline connection, one or more second encapsulated IP transport data packets, as described above.

Process 700 may include additional implementations, such as any single implementation or any combination of implementations described below and/or in connection with one or more other processes described elsewhere herein.

In a first implementation, each encapsulated IP transport data packet of the one or more first encapsulated IP transport data packets and the one or more second encapsulated IP transport data packets includes a GTP-U header.

In a second implementation, alone or in combination with the first implementation, process 700 includes the one or more first encapsulated IP transport data packets are sent via a GTP-U tunnel over the wireline connection, and the one or more second encapsulated IP transport data packets are received via the GTP-U tunnel.

In a third implementation, alone or in combination with one or more of the first and second implementations, each first encapsulated IP transport data packet of the one or more first encapsulated IP transport data packets includes a first header with a first TEID associated with the AGF device, and each second encapsulated IP transport data packet of the one or more second encapsulated IP transport data packets includes a second header with a second TEID associated with the client device.

In a fourth implementation, alone or in combination with one or more of the first through third implementations, each encapsulated IP transport data packet of the one or more first encapsulated IP transport data packets and the one or more second encapsulated IP transport data packets includes a header that includes QoS information.

In a fifth implementation, alone or in combination with one or more of the first through fourth implementations, the client device is a 5G-CRG.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

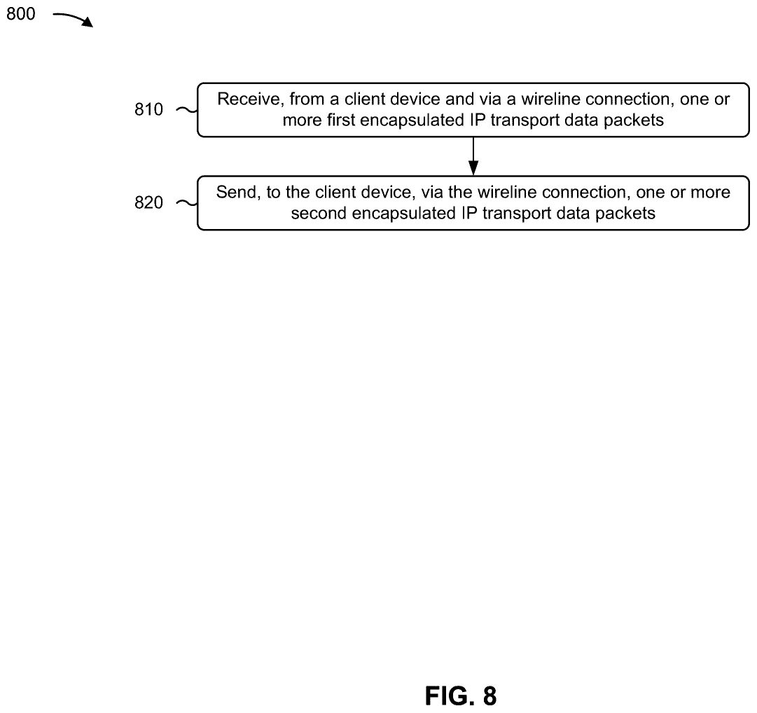

FIG. 8 is a flowchart of an example process 800 associated with encapsulated IP transport data packets communicated in cable networks. In some implementations, one or more process blocks of FIG. 8 are performed by an AGF device (e.g., AGF 415). In some implementations, one or more process blocks of FIG. 8 are performed by another device or a group of devices separate from or including the AGF device, such as a client device (e.g., client device 405) and/or a UPF device (e.g., UPF 430). Additionally, or alternatively, one or more process blocks of FIG. 8 may be performed by one or more components of device 500, such as processor 520, memory 530, input component 540, output component 550, and/or communication component 560. Additionally, or alternatively, one or more process blocks of FIG. 8 may be performed by one or more components of device 600, such as input component 610, switching component 620, output component 630, and/or controller 640.

As shown in FIG. 8, process 800 may include receiving, from a client device and via a wireline connection, one or more first encapsulated IP transport data packets (block 810). For example, the AGF device may receive, from a client device and via a wireline connection, one or more first encapsulated IP transport data packets, as described above.

As further shown in FIG. 8, process 800 may include sending, to the client device, via the wireline connection, one or more second encapsulated IP transport data packets (block 820). For example, the AGF device may send, to the client device, via the wireline connection, one or more second encapsulated IP transport data packets, as described above.

Process 800 may include additional implementations, such as any single implementation or any combination of implementations described below and/or in connection with one or more other processes described elsewhere herein.

In a first implementation, each encapsulated IP transport data packet of the one or more first encapsulated IP transport data packets and the one or more second encapsulated IP transport data packets includes a GTP-U header.

In a second implementation, alone or in combination with the first implementation, process 800 includes receiving the one or more first encapsulated IP transport data packets via a GTP-U tunnel over the wireline connection, and sending the one or more second encapsulated IP transport data packets via the GTP-U tunnel.

In a third implementation, alone or in combination with one or more of the first and second implementations, process 800 includes decapsulating the one or more first encapsulated IP transport data packets, generating, based on the decapsulated one or more first encapsulated IP transport data packets, one or more third encapsulated IP transport data packets, and sending the one or more third encapsulated IP transport data packets to a UPF device.

In a fourth implementation, alone or in combination with one or more of the first through third implementations, sending the one or more third encapsulated IP transport data packets includes sending the one or more third encapsulated IP transport data packets in accordance with QoS information included in a header of the one or more first encapsulated IP transport data packets.

In a fifth implementation, alone or in combination with one or more of the first through fourth implementations, process 800 includes receiving, from a UPF device, one or more third encapsulated IP transport data packets, decapsulating the one or more third encapsulated IP transport data packets, and generating, based on the decapsulated one or more third encapsulated IP transport data packets, the one or more second encapsulated IP transport data packets.

In a sixth implementation, alone or in combination with one or more of the first through fifth implementations, sending the one or more second encapsulated IP transport data packets includes sending the one or more second encapsulated IP transport data packets in accordance with QoS information included in a header of the one or more third encapsulated IP transport data packets.

In a seventh implementation, alone or in combination with one or more of the first through sixth implementations, each first encapsulated IP transport data packet of the one or more first encapsulated IP transport data packets includes a first header with a first TEID associated with the AGF device, and each second encapsulated IP transport data packet of the one or more second encapsulated IP transport data packets includes a second header with a second TEID associated with the client device.

In an eighth implementation, alone or in combination with one or more of the first through seventh implementations, each encapsulated IP transport data packet of the one or more first encapsulated IP transport data packets and the one or more second encapsulated IP transport data packets includes a header that includes QoS information.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, traffic or content may include a set of packets. A packet may refer to a communication structure for communicating information, such as a protocol data unit (PDU), a service data unit (SDU), a network packet, a datagram, a segment, a message, a block, a frame (e.g., an Ethernet frame), a portion of any of the above, and/or another type of formatted or unformatted unit of data capable of being transmitted via a network.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors to: perform X; perform Y; and perform Z,” that claim should be interpreted to mean “one or more processors to perform X; one or more (possibly different) processors to perform Y; and one or more (also possibly different) processors to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
sending, by a client device, to an access gateway function (AGF) device, and via a wireline connection, one or more first encapsulated Internet protocol (IP) transport data packets; and
receiving, by the client device, from the AGF device, and via the wireline connection, one or more second encapsulated IP transport data packets.

2. The method of claim 1, wherein each encapsulated IP transport data packet of the one or more first encapsulated IP transport data packets and the one or more second encapsulated IP transport data packets includes a general packet radio service (GPRS) tunneling protocol (GTP) for user data (GTP-U) header.

3. The method of claim 1, wherein:
the one or more first encapsulated IP transport data packets are sent via a general packet radio service (GPRS) tunneling protocol (GTP) for user data (GTP-U) tunnel over the wireline connection; and
the one or more second encapsulated IP transport data packets are received via the GTP-U tunnel.

4. The method of claim 1, wherein:
each first encapsulated IP transport data packet of the one or more first encapsulated IP transport data packets includes a first header with a first tunnel endpoint identifier (TEID) associated with the AGF device; and
each second encapsulated IP transport data packet of the one or more second encapsulated IP transport data packets includes a second header with a second TEID associated with the client device.

5. The method of claim 1, wherein each encapsulated IP transport data packet of the one or more first encapsulated IP transport data packets and the one or more second encapsulated IP transport data packets includes a header that includes quality of service (QoS) information.

6. The method of claim 1, wherein the client device is a fifth generation (5G) cable residential gateway (5G-CRG).

7. An access gateway function (AGF) device, comprising:
one or more memories; and
one or more processors to:
receive, from a client device and via a wireline connection, one or more first encapsulated Internet protocol (IP) transport data packets; and
send, to the client device, via the wireline connection, one or more second encapsulated IP transport data packets.

8. The AGF device of claim 7, wherein each encapsulated IP transport data packet of the one or more first encapsulated IP transport data packets and the one or more second encapsulated IP transport data packets includes a general packet radio service (GPRS) tunneling protocol (GTP) for user data (GTP-U) header.

9. The AGF device of claim 7, wherein:
the one or more processors, to receive the one or more first encapsulated IP transport data packets, are to receive the one or more first encapsulated IP transport data packets via a general packet radio service (GPRS) tunneling protocol (GTP) for user data (GTP-U) tunnel over the wireline connection; and
the one or more processors, to send the one or more second encapsulated IP transport data packets, are to send the one or more second encapsulated IP transport data packets via the GTP-U tunnel.

10. The AGF device of claim 7, wherein the one or more processors are further to:
decapsulate the one or more first encapsulated IP transport data packets;
generate, based on the decapsulated one or more first encapsulated IP transport data packets, one or more third encapsulated IP transport data packets; and
send the one or more third encapsulated IP transport data packets to a user plane function (UPF) device.

11. The AGF device of claim 10, wherein the one or more processors, to send the one or more third encapsulated IP transport data packets, are to send the one or more third encapsulated IP transport data packets in accordance with quality of service (QoS) information included in a header of the one or more first encapsulated IP transport data packets.

12. The AGF device of claim 7, wherein the one or more processors are further to:
receive, from a user plane function (UPF) device, one or more third encapsulated IP transport data packets;
decapsulate the one or more third encapsulated IP transport data packets; and
generate, based on the decapsulated one or more third encapsulated IP transport data packets, the one or more second encapsulated IP transport data packets.

13. The AGF device of claim 12, wherein the one or more processors, to send the one or more second encapsulated IP transport data packets, are to send the one or more second encapsulated IP transport data packets in accordance with quality of service (QoS) information included in a header of the one or more third encapsulated IP transport data packets.

14. The AGF device of claim 7, wherein:
each first encapsulated IP transport data packet of the one or more first encapsulated IP transport data packets includes a first header with a first tunnel endpoint identifier (TEID) associated with the AGF device; and
each second encapsulated IP transport data packet of the one or more second encapsulated IP transport data packets includes a second header with a second TEID associated with the client device.

15. The AGF device of claim 7, wherein each encapsulated IP transport data packet of the one or more first encapsulated IP transport data packets and the one or more second encapsulated IP transport data packets includes a header that includes quality of service (QoS) information.

16. A non-transitory computer-readable medium storing a set of instructions, the set of instructions comprising:
one or more instructions that, when executed by one or more processors of an access gateway function (AGF) device, cause the AGF device to:
receive, from a client device and via a wireline connection, one or more first encapsulated Internet protocol (IP) transport data packets; and
send, to a user plane function (UPF) device, based on the one or more first encapsulated IP transport data packets, one or more second encapsulated IP transport data packets.

17. The non-transitory computer-readable medium of claim 16, wherein each first encapsulated IP transport data packet, of the one or more first encapsulated IP transport data packets, includes a general packet radio service (GPRS) tunneling protocol (GTP) for user data (GTP-U) header.

18. The non-transitory computer-readable medium of claim 16, wherein the one or more instructions, that cause the AGF device to receive one or more first encapsulated IP transport data packets, cause the AGF device to receive the one or more first encapsulated IP transport data packets via a general packet radio service (GPRS) tunneling protocol (GTP) for user data (GTP-U) tunnel over the wireline connection.

19. The non-transitory computer-readable medium of claim 16, wherein the one or more instructions, that cause the AGF device to send the one or more second encapsulated IP transport data packets, cause the AGF device to:
decapsulate the one or more first encapsulated IP transport data packets; and
generate, based on the decapsulated one or more first encapsulated IP transport data packets, the one or more second encapsulated IP transport data packets.

20. The non-transitory computer-readable medium of claim 16, wherein each encapsulated IP transport data packet of the one or more first encapsulated IP transport data packets includes a header that includes quality of service (QoS) information.
